(19) United States
(12) Patent Application Publication
(10) Pub. No.: US 2015/0352953 A1
(43) Pub. Date: Dec. 10, 2015

(54) VEHICLE CONTROL SYSTEM WITH MOBILE DEVICE INTERFACE

(71) Applicant: MAGNA ELECTRONICS INC., Auburn Hills, MI (US)

(72) Inventor: Krishna Koravadi, Rochester Hills, MI (US)

(21) Appl. No.: 14/730,544

(22) Filed: Jun. 4, 2015

Related U.S. Application Data
(60) Provisional application No. 62/121,033, filed on Feb. 26, 2015.
(60) Provisional application No. 62/007,542, filed on Jun. 4, 2014.

(51) Int. Cl. B60K 35/00; H04L 29/08; B60H 1/00; H04W 76/02

(52) U.S. Cl. CPC B60K 35/00; H04W 76/023; H04L 67/12; B60H 1/00642; B60K 2350/106

(57) ABSTRACT

A vehicle control system includes a control and a communication link. The communication link receives a signal from a mobile device of a driver of a vehicle equipped with the vehicle control system. Responsive to receipt of a signal from the mobile device via the communication link, the control is operable to at least one of (i) determine a user input at the mobile device and control at least one accessory of the vehicle responsive to the determined user input and (ii) display at a display device of the vehicle visual content displayed at a display screen of the mobile device.

### CROSS REFERENCE TO RELATED APPLICATIONS

The present application claims the filing benefits of U.S. provisional applications Ser. No. 62/121,033, filed Feb. 26, 2015, and Ser. No. 62/007,542, filed Jun. 4, 2014, which are hereby incorporated herein by reference in their entireties.

### FIELD OF THE INVENTION

The present invention relates generally to a vehicle control and display system for a vehicle and, more particularly, to a vehicle control and display system that controls one or more systems of the vehicle responsive to a user input.

### BACKGROUND OF THE INVENTION

In recent years, improvements are being made for the comfort and safety in the automotive industry. Many vehicles allow the driver to register a mobile device with the vehicle using a wireless link and using a button located in the steering wheel to have minimum control of the mobile device, such as answer a phone call, or where a driver could use a voice command to call a person and if there is no exact match then scroll through a list using the central console to select the name to call. Such actions require that the driver take his or her view out-off the road, which leads to unsafe driving conditions.

In U.S. Publication No. US-2013-0145297, a configurable heads-up vehicle dash display is described where the driver can view the contents of the dash board on the HUD. However, it does not address or suggest a solution to display the contents of the mobile device in the HUD. In U.S. Pat. No. 8,831,826, a gesture recognition of the hand and control of the dash board is described, but the disclosed methods and systems require gesture recognition hardware be installed as a part of the central console and the gesture recognition area will be limited (near the central console stack). In U.S. Pat. No. 8,503,762, methods and systems for projecting a location based elements over a heads up display are described, but it does not address the issue discussed above related to the navigation/control of the mobile device by viewing the device's contents in the HUD unit.

### SUMMARY OF THE INVENTION

The present invention provides a communication and/or vision system or display system for a vehicle that communicates with a mobile device of the driver of the vehicle to at least one of (i) determine user inputs at the mobile device that are used to control one or more accessories of the vehicle and (ii) display at a display screen or area of the vehicle the visual content displayed at a display screen of the mobile device. The present invention thus allows a driver of a vehicle to use his or her mobile device to control one or more accessories of the vehicle (such as the radio or infotainment system, a telematics system, an HVAC system, a display system or the like). The present invention also displays the displayed images of the driver's mobile device at a display screen or area (such as a heads up display) where the driver can view the displayed images or information while driving the vehicle.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior of a vehicle, showing use of a mobile device to communicate with vehicle systems in accordance with the present invention;

FIG. 2 is a schematic of the mobile device communication system of the present invention;

FIG. 3 is another schematic of the mobile device communication system of the present invention;

FIG. 4 is a schematic of a mobile device and camera system for a vehicle in accordance with the present invention;

FIG. 5 is a fragmentary perspective view showing a shared HUD display layout at the vehicle windshield with the driver controlling the mobile device while viewing the mobile device information at the HUD display;

FIG. 6 is a side view of the scene shown in FIG. 5, showing that, while driving the vehicle, the driver is not looking at the mobile device to control or navigate while controlling the mobile device;

FIG. 7 is a functional block diagram of the present invention, with a mobile device that can be held in a non-driving hand of the driver, where the mobile device communicates with a HUD display via a wireless link to display the view and receives the commands from the driver via touch and/or audio command interfaces and communicates with the driver using audio out;

FIG. 8 is a perspective view of a smart glove of the present invention, which is capable of detecting a hand gesture to control and navigate a mobile device/central console stack;

FIG. 9 is a functional block diagram of the present invention similar to FIG. 7, shown with a wireless link interface with the smart glove of FIG. 8;

FIG. 10 is a fragmentary perspective view showing an option of hand gesture detection using an in-cabin camera;

FIG. 11 is a functional block diagram of the present invention similar to FIG. 7, shown with a wireless link interface with the smart camera of FIG. 10; and

FIG. 12 is a functional block diagram of the present invention similar to FIG. 7, shown with a central control/radio stack in the loop.

### LEGEND

10 reserved location of HUD area on the windshield
11 general area of the HUD for the vehicle feature display
12 HUD display
13 mobile device
14 non driving hand
16 view data from mobile device via wireless link
17 view data from the vehicle modules
18 voice command and audio interface to the driver
19 gyro sensors installed in the finger of the gloves
20 internal processing and communication unit
21 smart gloves with hand gesture recognition capability
22 wireless communication link between smart gloves and mobile device
23 in-cabin camera capable of detecting and/or recognizing hand gestures
24 no-driving hand used for the gesture control
25 windshield
26 virtual image in front of the windshield
27 holding the steering wheel using one hand
28 central console or radio stack
29 view data from central console/radio stack
30 wireless communication between 28 and 13
31 wireless communication link between in-cabin camera and mobile device
101 dashboard of the vehicle
102 infotainment system of the vehicle
103 wireless charging station of the vehicle
104 mobile device

### DESCRIPTION OF THE PREFERRED EMBODIMENTS

Mobile devices are becoming an integral part of human day to day life, with the devices becoming “smarter” so as to understand the visual, audio, gesture, touch interaction of the user. These capabilities of the mobile device may be utilized in a very effective way as a personal assistant in a vehicle, such as to control the vehicle infotainment system, display system, windows, wipers and/or the like. Instead of incorporating a lot of intelligence or circuitry or processing capabilities in the vehicle infotainment system to recognize voice commands (it may take a lot of effort to achieve a reliable performance with different pronunciation and different languages), additional hardware to recognize gesture and additional hardware to recognize touch commands, this (and the associated costs) could all be reduced or limited by utilizing the mobile device more effectively.

The present invention provides a system that links or communicates with a mobile device of the driver (such as via a wireless communication link or a wired communication link), whereby inputs at the mobile device can control a vehicle accessory or system or a display device. Optionally, the visual information or content displayed at the display screen of the mobile device may be displayed at a display screen of the vehicle (such as a heads-up display of the vehicle), so that the driver may view the mobile device displayed information without taking his or her eyes off the road while driving the vehicle.

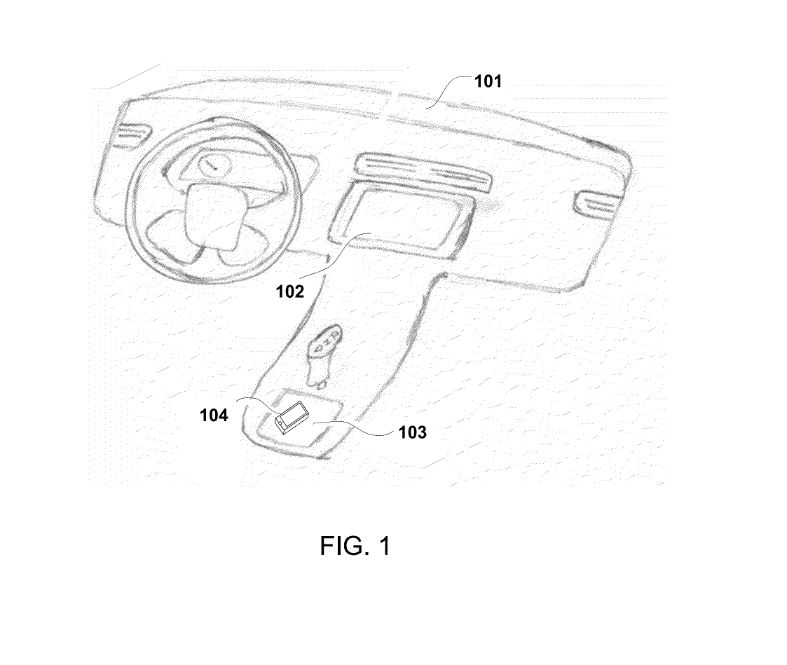

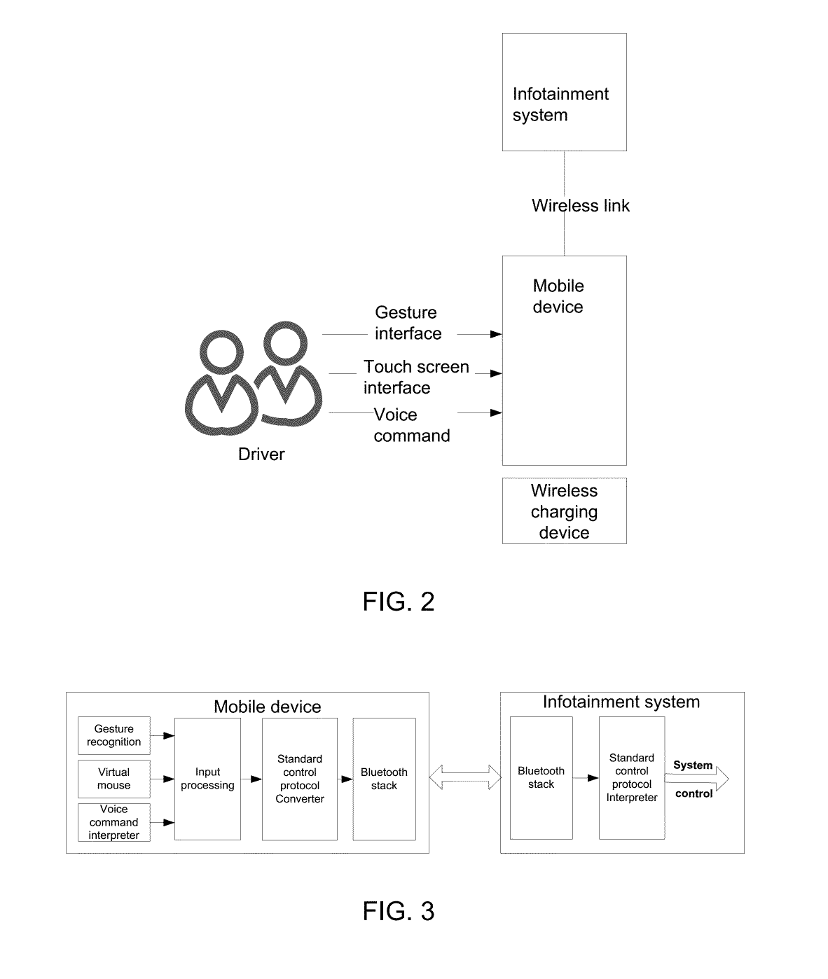

In accordance with the present invention, a vehicle communication system may communicate with a mobile device or smart phone, whereby a user may use his or her mobile device to control one or more accessories of the vehicle. For example, and with reference to FIGS. 1-3, a driver may establish a communication link between a mobile device 104 and an infotainment system 102 of the vehicle, such as may be installed in the dash board 101 of the vehicle. Because a mobile device may be active most of the time, it may be important to keep charging the mobile device when it is in the vehicle, such as by using a wireless charging station 103. A standard protocol may be provided so that the infotainment system could understand the communication protocol of the mobile device to allow the mobile device to control the infotainment system, windows, wipers and/or the like. As shown in FIG. 3, the mobile device may have the user inputs or interfaces and the processing capabilities and a protocol converter, whereby signals (derived from processing of inputs and converting of the processed inputs) are communicated (such as via BLUETOOTH® or the like) to the vehicle accessories or systems, such as to the vehicle infotainment system, whereby a protocol interpreter interprets the communication signals and controls the vehicle system or systems accordingly.

Optionally, the driver may use voice commands (using his or her own language, which the mobile device or smart phone would be programmed to understand) to command the mobile device to control the vehicle infotainment system (such as to go to the next screen, select a different music station, change the cabin temperature and/or the like). The driver may also or otherwise use the mobile device as a virtual mouse, such as by using a touch screen interface at the mobile device, to browse and control the infotainment system screen or the like. The driver may lift the mobile device or phone in the air by hand and may move the device or phone to make different gestures, whereby (because most mobile devices are now equipped with gyro sensors or the like), the system may recognize the gestures and translate the gesture commands to appropriate standard protocol commands, such as to control the infotainment system of the vehicle or the HVAC or climate control system of the vehicle or the like.

Optionally, the mobile device or smart phone communication link or system may also be used for providing an economical rear backup camera and display system for a vehicle not already equipped with a rear backup camera. In economical middle/low end vehicles, the vehicles do not include a rear camera and display system, such that accidents may occur when backing up the vehicle. For this reason, in the future, it will be mandated that most or all vehicles have rear view cameras to assist the driver during a reversing maneuver. However, there are many vehicles on the roads today that do not have a rear camera or a display screen, so that a rear vision system would be costly to implement on such vehicles.

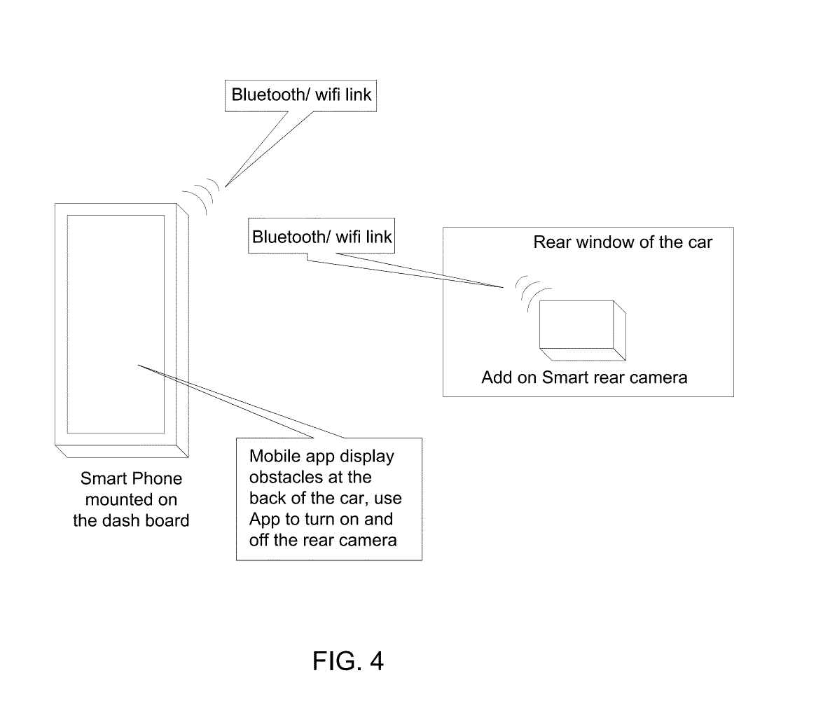

Optionally, and with reference to FIG. 4, a smart camera may be mounted at the rear window of vehicle (with the camera preferably providing a 180 degree view to the rear of the vehicle). The camera may communicate with a mobile phone (such as by using a Bluetooth/Wi-Fi link or the like) that is within the vehicle cabin. Thus, images of the rearward scene behind the vehicle (derived from image data captured by the smart camera) may be displayed on the screen of the smart phone or mobile device. The mobile phone may be mounted on the dash board of the vehicle so that the driver could readily look at the display during a reversing maneuver of the vehicle and backup the vehicle safely. Optionally, the images displayed by the mobile device may also be displayed at a display screen of the vehicle, such as via communication from the mobile device to a display system of the vehicle, as discussed below. Optionally, an app may control the camera and may switch the rear camera on or off remotely. The smart camera may be operated by a battery (not much wiring changes) or it could be connected to the 12 volt supply (such as via a wiring harness of the vehicle or the like).

If a Bluetooth link is used, the smart camera may perform object detection (via image processing of image data captured by the smart camera) and may transmit the information to the app of the smart phone (optionally, the smart phone app may process image data received from the camera to perform object detection). The app will reconstruct the scenario using the object information transmitted by the rear view smart camera and may then display warning alerts as well as guide the driver during the vehicle backup/parking maneuver. Thus, the camera and smart phone system may have a substantial market as an add-on product and/or the system may be adopted for (and may reduce the cost of) adding a display system (such as a separate display screen or a heads up display or the like) by utilizing the mobile phone as the display unit.

The communication systems may utilize aspects of the systems described in U.S. Publication Nos. US-2014-0218529; US-2014-0375476 and/or US-2015-0124096, which are hereby incorporated herein by reference in their entireties.

Optionally, the present invention may provide for human machine interface in a vehicle, and may provide a shared HUD (Heads Up Display) unit to view the content of the mobile device. The driver of the vehicle can then use his or her smart phone, such as to make a phone call or use voice commands to navigate through menus or apps on the phone or even to send a text message, all while viewing the display of the smart phone at the vehicle windshield (via the Heads Up Display) so that the driver can use the smart phone without taking his or her eyes off the road while driving.

If the driver of a vehicle wants to navigate/control his or her mobile device and select an application or browse the web to select news content to read or type a letter for search, there is no solution that does not require the driver to take his or her view off the road and to look at the mobile device screen. Even with voice command assisted technologies that are being adopted to improve the HMI control, it will difficult to control/navigate the screen without looking at the screen contents, and it will be better to have a solution that combines the touch interface, view of the contents on HUD screen to select with audio assist to read the contents.

The present invention provides a method and apparatus for viewing the content of the driver's (or passenger's) mobile device (such as a smart phone or the like) in the area of the heads up display and for controlling the mobile device using touch interface of the device or using a gesture control method using smart gloves or using an in-cabin camera or monitoring system, thus facilitating control and viewing of information without requiring that the driver take his or her view off the road, thereby improving safety. The system and method of the present invention may also be used for controlling or navigating menus at the center console display or radio without taking the driver's view off the road.

The system of the present invention provides different methods of controlling or navigating the mobile device or center console display or radio:
a. control or navigation of the mobile device using a non-driving hand and looking at the mobile screen in the HUD shared display;
b. a gesture control method using a smart in-cabin imaging camera that is wirelessly connected with mobile device;
c. control of the mobile device by wearing a smart glove on a non-driving hand that is capable of detecting hand gesture positions that is wirelessly connected to the mobile device; and/or
d. using the mobile device touch screen as a virtual mouse to navigate and control the central console or radio stack.

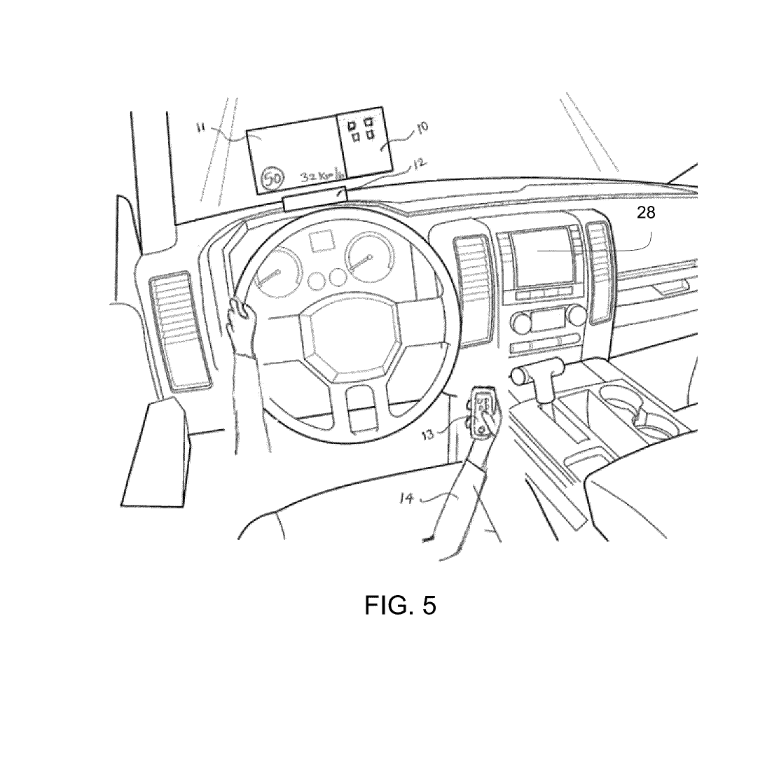

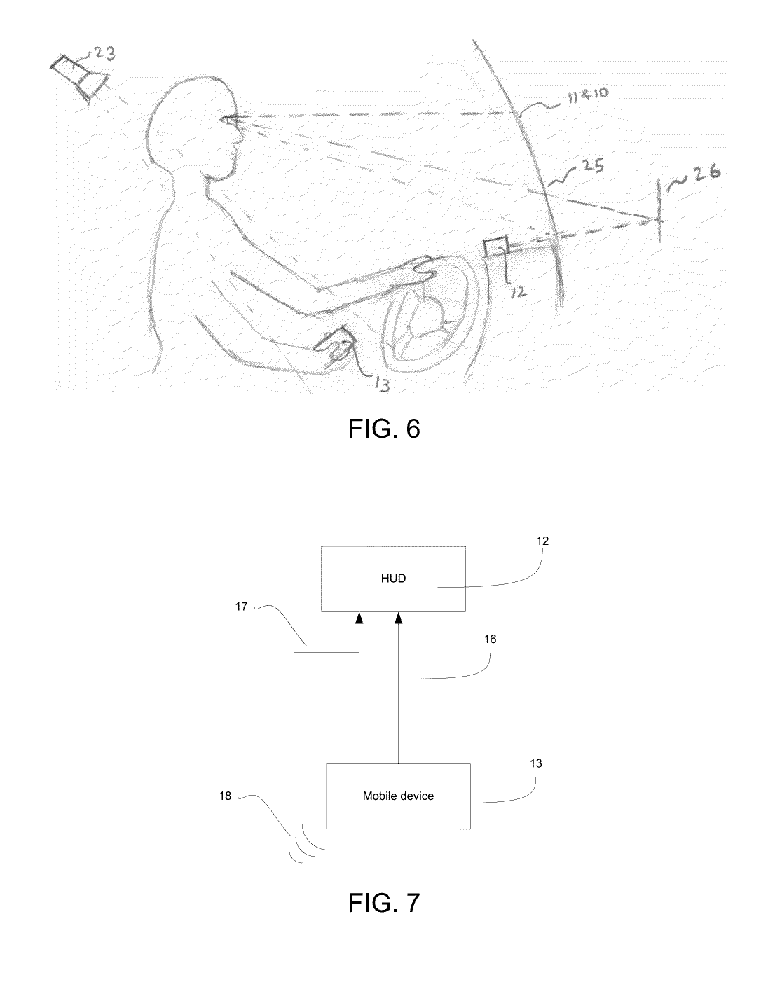

Referring to FIGS. 5 and 6, a vehicle is equipped with a system of the present invention, which has a heads up display unit 12 that has a capability to provide a view with a reserved area 10 for the mobile device 13 or center console 28 contents in addition to the area 11 for regular capability of heads up display unit. As shown in FIGS. 5 and 6, the driver is holding the mobile device using a non-driving hand 14 while driving the vehicle, and the driver is not looking at the mobile device 13 screen to control or navigate the mobile device 14 as the contents of the mobile device 13 screen are optionally center console screen displayed in the area 10. The HUD 12 projects the visual input on the windshield 25 and creates a virtual image 26 at a distance from the windshield. Optionally, if an in-cabin smart camera 23 is capable of recognizing hand gestures, such information may be communicated with the mobile device using a wireless link.

Referring to FIG. 7, a vehicle configuration is shown with a mobile device 13 connected to HUD unit 12 via a wireless link 16 in accordance with the present invention. The HUD device also receives visual data or image data from link 17 from other vehicle modules. Optionally, only a voice command is used to control the mobile device to improve the safety while the driver is driving the vehicle without taking the view off the road, but it will not be easy to navigate and have complete control of the mobile device without touch interface. The present invention thus provides the combination of a touch input and voice commands to navigate and control the mobile device with the driver not taking his or her view off the road.

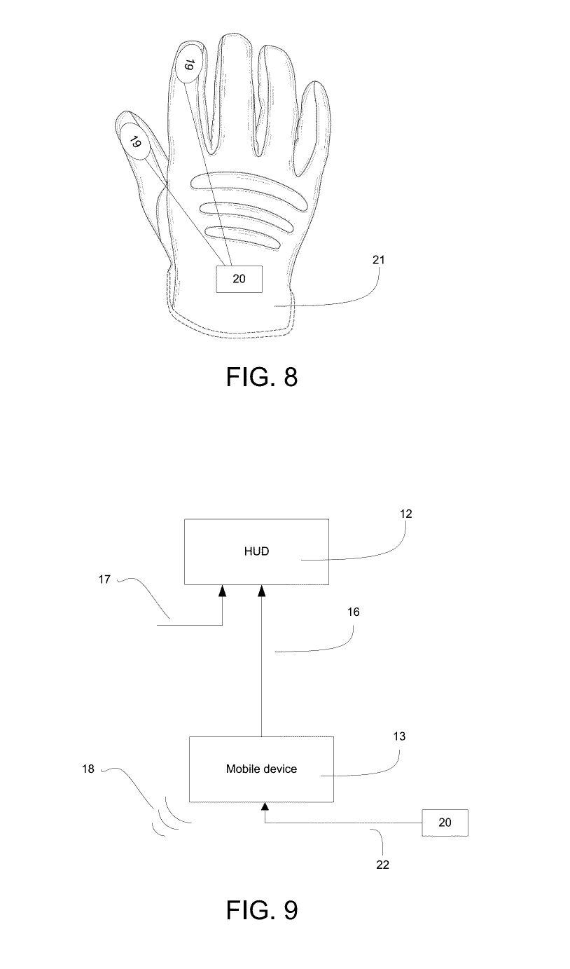

Referring to FIGS. 8 and 9, a vehicle configuration similar to FIG. 7 is shown, but with the mobile device 13 controlled/navigated using a smart glove 21 and voice command interface 18. Smart glove 21 is used by the driver using the non-driving hand and commands/controls/navigates the mobile device in combination with voice commands, whereby the driver can view the contents of the mobile device screen at the windshield location 10 without taking view out of the road. The smart glove is able to recognize the hand gesture using gyro sensors located in individual fingers 19 and to communicate with the mobile device via the wireless link 22.

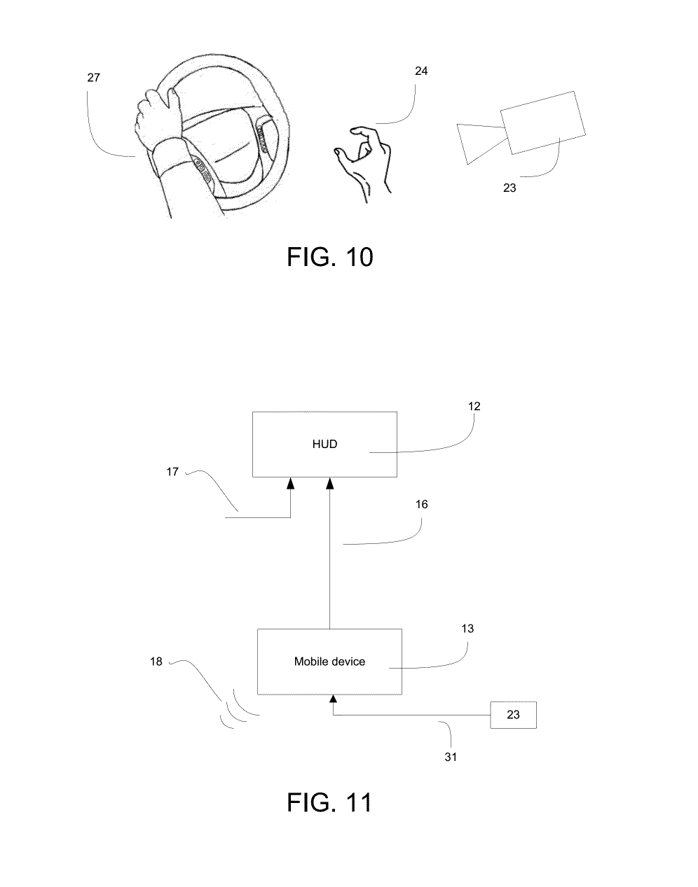

Referring to FIGS. 10 and 11, a vehicle configuration similar to FIG. 7 is shown, but the mobile device 13 is controlled/navigated using the gesture control of the non-driving hand 24 which is detected by the in-cabin camera 23 and communicated to the mobile device 13 via the wireless link 31.

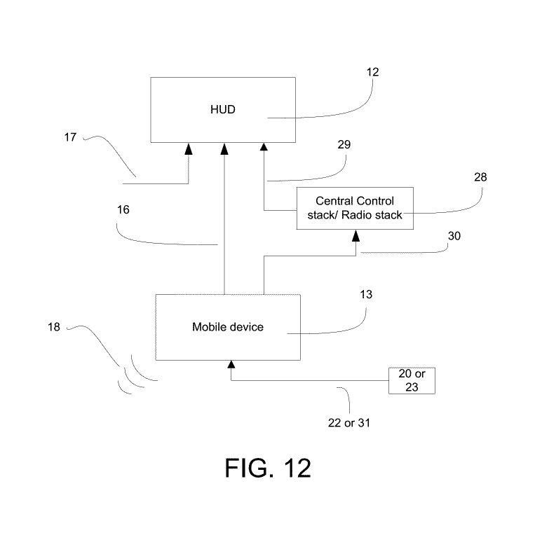

Referring to FIG. 12, a vehicle configuration is shown that comprises a HUD unit 12 that could receive the view data from a vehicle system via link 17 and view data from the mobile device via wireless link 16 or connected to the central console/radio stack 28 via link 29. The mobile device 13 may be connected to the central console/radio stack 28 via a wireless link 30 (or a wired link).

In the system configuration with central console/radio stack 28 and mobile device 13, only without a smart glove and processing unit and camera, the driver may use the mobile device and configure the HUD 12 to take the view data from the central console/radio stack 28 and the mobile device's touch screen can be used as a remote device (such as like a mouse) to navigate and control the central console/radio stack 28 and view the contents of 28 in the HUD area 10. When the driver would like to view the contents of the mobile device 13, the user can configure the HUD 12 using the mobile device 13 to take the view data from the mobile device and the user can use the non-driving hand 14 to navigate/control the mobile device while viewing its display screen information at the HUD display area 10.

In the system configuration with the central console/radio stack 28, mobile device 13, HUD 12 and smart gloves 21, the operation is similar to the systems discussed above, with a detection of hand gesture used for the navigation and control of the mobile device or the central console/radio stack.

In the system configuration with the central console/radio stack 28, mobile device 13, HUD 12 and in-cabin camera 23, the operation is similar the systems discussed above, with a detection of hand gestures (by the camera or interior monitoring system) used for the navigation and control of the mobile device or the central console/radio stack.

The camera and gesture detection or recognition systems may utilize aspects of the systems described in U.S. Pat. No. 7,914,187 and/or U.S. Publication Nos. US-2015-0009010; US-2014-0336876; US-2012-0218412; US-2012-0062743 and/or US-2013-0222592, and/or U.S. patent application Ser. No. 14/675,926, filed Apr. 1, 2015 (Attorney Docket MAGO4 P-2411), Ser. No. 14/675,929, filed Apr. 1, 2015 (Attorney Docket MAGO4 P-2493), Ser. No. 14/561,794, filed Dec. 5, 2014 (Attorney Docket MAGO4 P-2415) and/or Ser. No. 14/623,690, filed Feb. 17, 2015 (Attorney Docket MAGO4 P-2457), and/or International Publication Nos. WO 2014/204794 and/or WO 2013/109869, which are all hereby incorporated herein by reference in their entireties.

In the systems described above that utilize a camera, the camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described International Publication Nos. WO 2010/099416; WO 2011/028686; WO 2012/075250; WO 2013/019795; WO 2012-075250; WO 2012/145822; WO 2013/081985; WO 2013/086249 and/or WO 2013/109869, and/or U.S. Publication No. US-2012-0162427, which are hereby incorporated herein by reference in their entireties.

Optionally, a video mirror display may be disposed rearward of and behind the reflective element assembly and may comprise a display such as the types disclosed in U.S. Pat. Nos. 5,530,240; 6,329,925; 7,855,755; 7,626,749; 7,581,859; 7,446,650; 7,370,983; 7,338,177; 7,274,501; 7,255,451; 7,195,381; 7,184,190; 5,668,663; 5,724,187 and/or 6,690,268, and/or in U.S. Publication Nos. US-2006-0061008 and/or US-2006-0050018, which are all hereby incorporated herein by reference in their entireties. The display is viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates of the reflective element may be selected to provide a desired color or tint to the mirror reflective element, such as a blue colored reflector, such as is known in the art and such as described in U.S. Pat. Nos. 5,910,854; 6,420,036 and/or 7,274,501, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicle control system comprising:
a control;
a communication link for receiving a signal from a mobile device of a driver of a vehicle equipped with said vehicle control system; and
wherein, responsive to receipt of a signal from the mobile device via said communication link, said control is operable to at least one of (i) determine a user input at the mobile device and, responsive to the determined user input, said control controls at least one accessory of the vehicle, and (ii) display at a display device of the vehicle visual content displayed at a display screen of the mobile device.

2. The vehicle control system of claim 1, wherein, responsive to receipt of a signal from the mobile device, said control is operable to determine a user input at the mobile device and, responsive to the determined user input, said control controls at least one accessory of the vehicle.

3. The vehicle control system of claim 2, wherein the at least one accessory comprises at least one of (i) an infotainment system of the vehicle, (ii) a telematics system of the vehicle, (iii) a climate control system of the vehicle and (iv) a display system of the vehicle.

4. The vehicle control system of claim 2, wherein the user input is determined via a gesture recognition system to determine a gesture indicative of the user input by the driver of the vehicle.

5. The vehicle control system of claim 1, wherein, responsive to receipt of a signal from the mobile device, said control is operable to display at a display device of the vehicle visual content displayed at a display screen of the mobile device.

6. The vehicle control system of claim 5, wherein said display device comprises a heads up display that displays the visual content at a windshield area in front of the driver of the vehicle.

7. The vehicle control system of claim 6, wherein said display device displays the visual content of the mobile device at a portion of the windshield area and displays other information at another portion of the windshield area.

8. The vehicle control system of claim 6, wherein said display device displays the visual content of the mobile device as the driver uses the mobile device to ease the driver's ability to use functions of the mobile device without looking at the display screen of the mobile device.

9. The vehicle control system of claim 8, wherein, responsive to movement of the mobile device by the driver, said display device changes the information displayed at the windshield area.

10. The vehicle control system of claim 5, wherein the visual content of the mobile device that is displayed by said display device comprises video images captured by a camera disposed at a rear portion of the vehicle and viewing rearward of the vehicle.

11. The vehicle control system of claim 1, wherein said control is responsive to a gesture recognition system of the vehicle to determine a gesture indicative of a user input by the driver of the vehicle.

12. The vehicle control system of claim 11, wherein said gesture recognition system comprises a vision-based system having a camera viewing an interior region of the vehicle where a driver's hand may be positioned and wherein gestures are determined by processing of image data captured by the camera.

13. The vehicle control system of claim 11, wherein said gesture recognition system comprises a smart glove worn by the driver and wherein gestures are determined by movement of sensors of the smart glove.

14. The vehicle control system of claim 1, wherein said communication link comprises a wireless communication link.

15. A vehicle control system comprising:
a control;
a communication link for receiving a signal from a mobile device of a driver of a vehicle equipped with said vehicle control system;
wherein said communication link comprises a wireless communication link;
wherein, responsive to receipt of a signal from the mobile device via said communication link, said control is operable to display at a display device of the vehicle visual content displayed at a display screen of the mobile device;
wherein said display device comprises a heads up display that displays the visual content at a windshield area in front of the driver of the vehicle; and
wherein said display device displays the visual content of the mobile device as the driver uses the mobile device to ease the driver's ability to use functions of the mobile device without looking at the display screen of the mobile device.

16. The vehicle control system of claim 15, wherein said display device displays the visual content of the mobile device at a portion of the windshield area and displays other information at another portion of the windshield area.

17. The vehicle control system of claim 15, wherein the visual content of the mobile device that is displayed by said display device comprises video images captured by a camera disposed at a rear portion of the vehicle and viewing rearward of the vehicle.

18. A vehicle control system comprising:
a control;
a communication link for receiving a signal from a mobile device of a driver of a vehicle equipped with said vehicle control system;
wherein said communication link comprises a wireless communication link;
wherein, responsive to receipt of a signal from the mobile device via said communication link, said control is operable to determine a user input at the mobile device and, responsive to the determined user input, said control controls at least one accessory of the vehicle; and
wherein the at least one accessory comprises at least one of (i) an infotainment system of the vehicle, (ii) a telematics system of the vehicle, (iii) a climate control system of the vehicle and (iv) a display system of the vehicle.

19. The vehicle control system of claim 18, wherein, responsive to receipt of a signal from the mobile device, said control is operable to display at a display device of the vehicle visual content displayed at a display screen of the mobile device, and wherein said display device comprises a heads up display that displays the visual content at a windshield area in front of the driver of the vehicle, and wherein said display device displays the visual content of the mobile device as the driver uses the mobile device to ease the driver's ability to use functions of the mobile device without looking at the display screen of the mobile device.

20. The vehicle control system of claim 18, wherein said control is responsive to a gesture recognition system of the vehicle to determine a gesture indicative of a user input by the driver of the vehicle, and wherein said gesture recognition system comprises a vision-based system having a camera viewing an interior region of the vehicle where a driver's hand may be positioned and wherein gestures are determined by processing of image data captured by the camera.
